(19) United States
(12) Patent Application Publication
(10) Pub. No.: US 2012/0033920 A1
(43) Pub. Date: Feb. 9, 2012

(54) OPTICAL FIBER FERRULE

(75) Inventors: Edmund J. Haley, Dillsburg, PA (US); David Robert Baechtle, Dillsburg, PA (US)

(73) Assignee: Tyco Electronics Corporation, Berwyn, PA (US)

(21) Appl. No.: 12/855,237

(22) Filed: Aug. 12, 2010

Related U.S. Application Data
(60) Provisional application No. 61/371,469, filed on Aug. 6, 2010.

(51) Int. Cl. G02B 6/36

(52) U.S. Cl. 385/78

(57) ABSTRACT

The invention pertains to an optical ferrule and a method of manufacturing the optical ferrule that can compensate for the fact that the end faces of the fibers contained in the ferrule initially may not be coplanar of each other within required or desired tolerances or otherwise not the exact correct length. Particularly, a cavity is provided within the ferrule to provide room for the fibers to freely bend within at least a range of curvatures within the ferrule so that any difference in the lengths of the fibers can be compensated for by a unique amount of bend in each individual fiber.

### CROSS REFERENCE TO RELATED APPLICATIONS

This application claims the benefit of U.S. Provisional Patent Application No. 61/371,469, filed Aug. 6, 2010, the entire disclosure of which is hereby incorporated herein by reference.

### FIELD OF TECHNOLOGY

The invention pertains to optoelectronics. More particularly, the invention pertains to an optical ferrule and a technique for manufacturing the same.

### BACKGROUND

It is typically the case that an optical signal transported over an optical fiber must be coupled between that optical fiber and another optical fiber or an optoelectronic device. Typically, the end of the optical fiber is outfitted with an optical connector of a given form factor, which connector can be coupled to a mating optical connector of the same form factor outfitted on the other fiber (or optoelectronic device).

Optical cables that are connected to each other through a pair of mating connectors may comprise a single optical fiber. However, more and more commonly, optical cables contain a plurality of optical fibers (sometimes more than 1,000 fibers) and the light in each optical fiber in the cable is coupled through a pair of mating connectors to a corresponding optical fiber in another cable.

Optical connectors generally must be fabricated extremely precisely to ensure that as much light as possible is transmitted through the mating connectors so as to minimize signal loss during transmission. In a typical optical fiber, the light is generally contained only within the core of the fiber, which typically may be about 10 microns in diameter for a single-mode fiber or about 50 microns in diameter for a multi-mode fiber. Accordingly, lateral alignment of the fibers in one connector with the fibers in the other connector should be very precise.

Many different connectors are available on the market today, each having a unique form factor. Well known, standard optical connectors available today include MT, MPO, SC, FC, ST, LC, and SMC connectors.

Commonly, an optical connector comprises a ferrule (within which the fibers are laid out with their end faces substantially coplanar) enclosed within a connector housing. The connector housing usually provides coarse alignment of the ferrules with each other as well as a releasable latching mechanism for holding two such mated connectors together. The ferrules provide the fine alignment of the fibers, within tolerances as small as 1-2 microns or less.

### SUMMARY

The invention pertains to an optical ferrule and a method of manufacturing the optical ferrule that can compensate for the fact that the end faces of the fibers contained in the ferrule initially may not be coplanar of each other within required or desired tolerances or otherwise not the exact correct length. Particularly, a cavity is provided within the ferrule to provide room for the fibers to freely bend within at least a range of curvatures within the ferrule so that any difference in the lengths of the fibers can be compensated for by a unique amount of bend in each individual fiber. In one assembly process, the ends of the fibers are inserted into the ferrule with a portion of each fiber passing through the cavity. A bend is induced in each of the fibers in the cavity. For instance, a window may be provided in the ferrule that is in communication with the cavity. A tool can be inserted through the window into the cavity during assembly that pushes on all the fibers to initiate bends therein. Alternately, a plug may be provided for closing the window, the internal surface of the plug being convex and dimensioned to contact the fibers in the cavity and push them into bending. With bends induced in the fibers, the fibers may be pushed farther forward into the ferrule sufficiently to cause the end faces of even the shortest fibers to contact abutment surfaces, such as the rear ends of lenses in the bores. At that point, each individual fiber will uniquely bend a further amount as needed to take up any excess length of that particular fiber. In other embodiments, the fibers may be allowed to extend past the front face of the ferrule so that, when the ferrule is mated to another ferrule to make a fiber-to-fiber optical connection, the fibers will abut the endfaces of the fibers of the mating connector and uniquely bend further as needed.

### BRIEF DESCRIPTION OF THE DRAWINGS

FIG. 1A is a perspective view of an optical ferrule in accordance with an embodiment of the invention.

FIG. 1B is a sectional view taken through Section B-B of the ferrule of FIG. 1A.

FIG. 2A is a cross-sectional side view of a ferrule in accordance with an embodiment of the invention during a first assembly stage.

FIG. 2B is a horizontal sectional view of the ferrule of FIG. 2A during the first assembly stage.

FIG. 3 is a cross-sectional side view a ferrule during a second assembly stage.

FIG. 3 is a cross-sectional side view a ferrule during a third assembly stage.

FIG. 5 is a perspective view of a ferrule in accordance with an embodiment of the invention completely assembled.

### DETAILED DESCRIPTION OF EMBODIMENTS

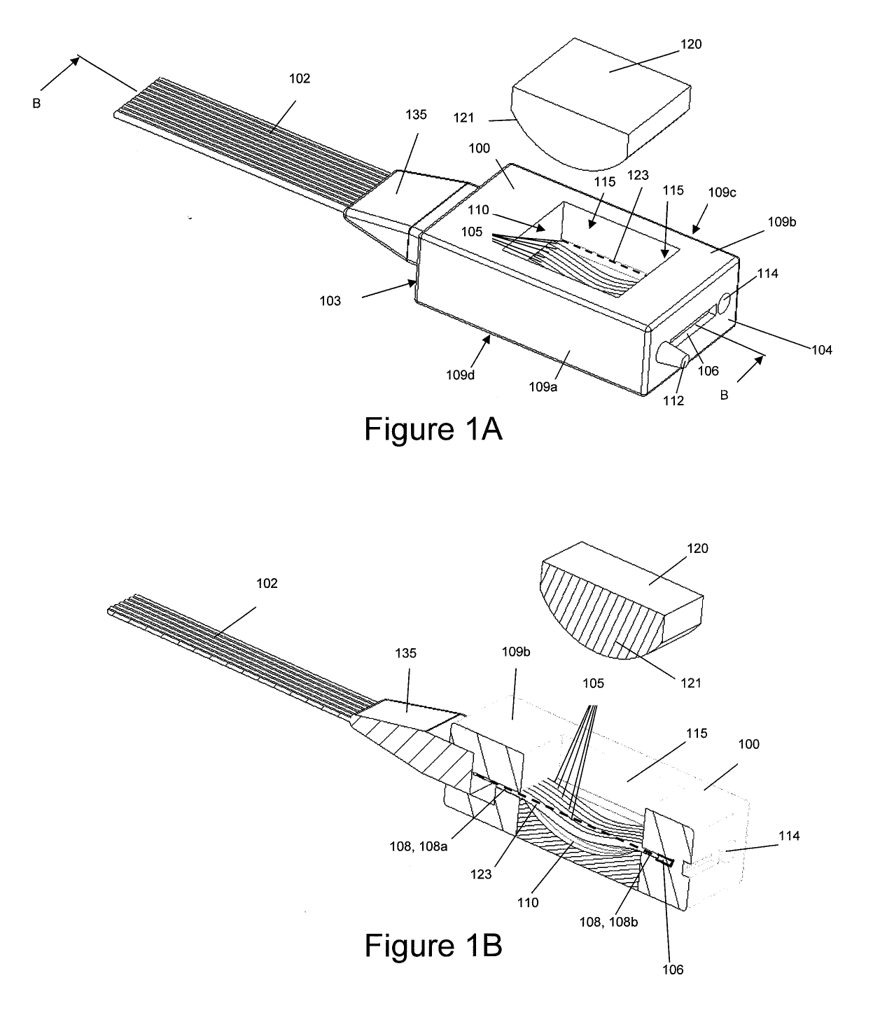

FIGS. 1A and 1B are perspective and sectional views, respectively, of a ferrule in accordance with an embodiment of the invention. This exemplary ferrule 100 terminates an optical cable 102 comprising a ribbon of 12 optical fibers 105.

To form a complete connector, the ferrule 100 commonly will be disposed within a connector housing (not shown), which housing will provide one or more of (1) protection from environmental factors, (2) a coarse alignment mechanism for aligning the ferrule with the ferrule of a mating connector, and (3) a releasable latching mechanism for holding two such connectors together.

The optical cable 102 comprises a plurality of optical transports, in this example optical fibers 105. The individual fibers 105 comprising the cable 102 are separated from each other near the end of the cable as they enter the rear face 103 of the ferrule 100 so that each fiber can be placed within its own individual bore 108 in the ferrule 100. As is typical, the ferrule 100 comprises a front face 104 that is intended to face the front face of a mating ferrule when two connectors are connected together and a rear face 103 through which the fibers 105 enter the ferrule 100. A side surface 109 (comprised of four planar sides 109a, 109b, 109c, 109d in this exemplary embodiment) extends longitudinally between the front and rear faces 104, 103. In this specification, the term longitudinally refers to the longitudinal direction of the optical fibers, which does not necessarily refer to a straight line since the fibers are flexible and may bend. The light from each fiber 105 in ferrule 100 couples to a corresponding fiber in the other connector through the front face 104 and vice versa. Exemplary ferrule 100 is a lensed ferrule, such as in an expanded beam connector or the like. Therefore, there is a lens 106 at the front end of each bore 108. Using an expanded beam connector as an example, the lens will expand the beam emanating from the end face of each fiber 105 to a larger cross section at the front face of the lens to provide better immunity to dirt and dust and better tolerance of lateral misalignment of the fibers as discussed above.

The front face 104 of the ferrule 100 further includes one or more alignment features 112, 114 adapted to mate with complementary alignment features on another ferrule so that two such ferrules may be mated facing each other with the fibers in one ferrule precisely aligned with the fibers in the other ferrule. In this example, the alignment features are a tapered pin 112 and a complementary tapered hole 114 so that two such ferrules can be hermaphroditically mated to each other facing each other with the pin 112 of each ferrule 100 entering into the hole 114 of the other. Each bore 108 is precisely aligned relative to the alignment features on the front face 104 of the ferrule 100. Further, the diameters of the bores are essentially equal to or slightly greater than the diameter of a fiber 105 so that each fiber 105 can be inserted freely through its respective bore 108 but fit relatively snugly in the bore so that the end face of the fiber and the lens will be very precisely positioned relative to the alignment features at the front face 104 of the ferrule 100. Consequently, the fibers 105 and lenses 106 in the bores 108 will align very precisely with the fibers and the lenses of another connector when the alignment features of two connectors are mated.

Each bore 108 may be considered to compromise two collinear segments, a rear segment 108a and a front segment 108b, interrupted by a cavity 110 in the middle of the ferrule 100 compromising an open space in which the fibers may bend. Thus, each individual fiber 105 is inserted into the ferrule 100 through a respective one of the rear bore segments 108a, travels through that rear bore segment into the cavity 110 and then continues into a corresponding collinear one of the front bore segments 108b. While, for a straight connector, collinear front and rear bore segments is probably the most practical implementation, it is not a requirement. Furthermore, other connectors may intentionally bend the fibers so that the front ends of the fibers are facing a different direction than the direction in which the fibers were running at or near the rear end of the connector body. For instance, right angle fiber optic connectors are known and used in applications where there is limited available space in front of a panel or bulkhead so that the fibers can run orthogonal to the panel a short distance from the panel. In such connectors therefore, the rear bore segments might be oriented at a 90° angle to the front bore segments. Furthermore, the ferrule is described herein as a unitary piece. However, it also is possible for the ferrule to be comprised of multiple assembled pieces. The rear bore segments therefore may be in a different piece than the front bore segments.

The end faces of the fibers 102 abut the rear faces of the lenses 106. The fibers 102 may be epoxied to the ferrule bores or to the lenses. Alternately, the fibers may be left free floating in the front bore segments 108b to permit movement of the fibers relative to other parts of the ferrule to permit for differences in thermal expansion coefficients without damage. Typically, the rear faces of all of the lenses 106 in such a connector are substantially coplanar (as are the front faces of the lenses). Thus, the end faces with the fibers 102 also should be cut substantially coplanar prior to assembly of the ferrule to the cable.

Note that the abutment face in the front bore segments need not be a lens. It can simply be a clear wall that the light may pass through without being refracted or diffracted.

The end faces of the fibers typically are cleaved such as by laser cleaving or mechanical cleaving. However, the cleaving process is not perfect and there are typically very small variations in the lengths of the individual fibers 105 in the cable 102 so that the end faces of the fibers are not perfectly coplanar, as desired. It is desirable for every fiber in a connector to abut the rear face of its lens so that the light emanating from the fiber (or entering the fiber from the other direction) travels from the fiber to the lens without passing through air. However, if the end faces of the fibers are not all coplanar, then only the longest fiber will actually abut the rear face of its corresponding lens and the remaining fibers will not.

This issue is addressed in the ferrule of FIGS. 1A and 1B by providing the cavity 110 in the middles of the bores 108 (between the rear segments 108a and the front segments 108b) that provides open space for the fibers 105 to bend within the ferrule 100, with each fiber 105 able to bend a different amount as needed to allow each fiber to contact the rear face of its respective lens 106.

All of the fibers will form bends in the cavity 110 as needed to allow the shortest fiber 105 to make contact with its lens 106. The longer fibers will bend more and the shorter fibers will bend less. In one embodiment, even the shortest fiber will bend because it will be desirable to ultimately push the cable into the ferrule a sufficient distance to assure that the end face of every fiber in the cable abuts the lens. This can be assured by guaranteeing that the cable is longitudinally pushed in an amount sufficient to assure that even the shortest possible fiber will bend. It is desirable that all of the fibers bend in the same general direction (i.e., the radii of the bends are all generally parallel to each other) so that the individual fibers 105 do not contact each other and physically interfere with each other's bending.

This can be accomplished in several ways. In one embodiment as illustrated, the cavity 110 is in communication with a window 115 in the side of the ferrule 100. A plug 120 may be introduced in the window 115, the plug 120 having an internal surface 121 (the surface that will be inside the ferrule facing the cavity) that is convex. As can be seen, the internal surface 121 of the plug 120 cap is arched in the direction from the rear of the ferrule to the front of the ferrule, i.e., the longitudinal direction of the fibers. Furthermore, its thickness is selected so that the at least some portion of the arched surface 121 intrudes into the space defined by the straight lines 123 between the rear bore segments 108a and the corresponding front bore segments 108b so that, as the plug 120 is inserted, the surface 121 will apply a lateral force against the fibers 105 in the cavity 110. Thus, each fiber 105, in fact, must bend around the arched surface 121 in order to extend from a rear bore segment 108a into a front bore segment 108b.

To assemble the cable 102 to the ferrule 100 in accordance with the principles of one embodiment, the individual fibers 105 of the cable are first inserted into their respective bores 108 a sufficient amount to assure that all of the fibers 105 extend through the rear bore segments 108a, the cavity 110, and into the front bore segments 108b, but do not yet abut the rear faces of the lenses 106. Then, the plug 120 may be introduced into the window to initiate bends in all of the fibers. Then, with the plug 120 in place in window 115 and the bends thereby initiated, the cable 102 can be pushed forward into the ferrule 100 a predetermined farther distance that will assure that the end face of even the shortest possible fiber will abut the rear face of its respective lens 106. Each fiber 105 (including the shortest fiber) will bend further as much as individually needed to take up any extra fiber length.

The cavity merely need provide open space between the arched surface and another surface of the cavity so that there is a range of curvatures to which the fibers may bend without interference.

In connectors where the direction of the fibers is changed in and/or near the connector such as the above-mentioned right angle connectors, the cavity can also serve double duty as the space in which some or all of the change in direction of the fibers occurs. For instance, in a right angle connector, the fibers may change direction by 90° in the cavity in addition to the various length fibers taking on slightly different bends to compensate for any differences in their lengths.

The plug 120 should be introduced into the window 115 after the fronts of the fibers 105 are already disposed in front bore segments 108b. Particularly, if the fibers 105 were bent in the cavity 110 before the front ends of the fibers 105 were already trapped within the front bore segments 108b, it would make it more difficult to subsequently get the front ends of the fibers to enter the front bore segments 108b (since the fibers would no longer be straight and collinear with the lines 123 between the corresponding rear and front bore segments).

On the other hand, in an alternative embodiment in which an arched surface such as surface 121 may be integrally formed in the cavity 110, this issue may be overcome by providing guide grooves in the surface 122 of the cavity 110 opposite the arched surface 121 that will guide the bent fibers 105 back down into the front bore segments 108b as they are pushed forward. This type of embodiment may be particularly suitable in applications where the fibers change directions within the ferrule, such as the aforementioned right angle connectors. In such cases, the fiber path between the rear bore segments and the front bore segments may not be straight lines, but rather curved paths, such that the fibers must bend within the ferrule before they can even enter the front bore segments. In such embodiments, the guide grooves may be formed in an internal wall of the cavity near the front bore segments to guide the fibers into the front bores as they are pushed in from the rear. However, in the middle and/or rear of the cavity, that wall should be spaced away from the natural path of the bent fibers that pass through the rear and front bore segments so that the fibers will not be in contact with the wall of the cavity for at least a portion of the longitudinal extent of the cavity. Specifically, each fiber should remain free and not in contact with a surface of the ferrule on the outside of the curve for at least a portion of its length within the cavity so that it may individually bend even further as needed.

In fact, in such embodiments, an arched surface intruding into the natural path of the fibers may even be completely omitted since the fibers will already be curved in the cavity.

In yet other embodiments, the bending of the fibers may be induced by a tool during assembly with no bend-inducing element remaining permanently in the actual ferrule itself. For instance, after the fibers 105 have been partially inserted as describe above (i.e., sufficiently to enter the front bore segments 108b, but not enough to contact the rear faces of the lenses 106), plug 120 may simply be positioned on a tool that introduces the plug through the window 115 to initiate bending of the fibers. Then, with the tool still in place, the cable 102 may be pushed forward the rest of the way to assure that the end faces of all of the fibers 105 abut the rear faces of the corresponding lenses 106. Then, the tool with plug 120 may be removed. Thereafter, the window may be closed by filling it with adhesive, or it may simply be left open.

While the invention has hereinabove been described in connection with lensed ferrules, this is merely exemplary. The invention may be employed in non-lensed connectors also. For instance, the invention may be incorporated into a connector in which the fibers of the two connectors are to contact each other endface-to-endface. In one such embodiment, a plate may be placed against the front face of the ferrule during assembly to provide a surface for the ends of the fibers to abut during assembly. The fibers may be epoxied to the front bore portions and, after the epoxy is cured, the plate can be removed and the fiber endfaces will remain flush with the front face of the ferrule.

In yet other embodiments, there may be no abutment surface in the front bore segments and the cavity and the curvature of the fibers within that cavity may be used to assist with fiber-to-fiber endface coupling between the fibers in the connector and the fibers in another connector to which it is mated. Specifically, most if not all optical transports are elastically resilient in that they would return to the straight condition in the absence of a contrary force. Hence, in direct fiber-to-fiber connectors, the arched surface can be used to initiate curves in the cavity in all of the fibers in a connector, but the fibers may be allowed to extend completely through and out of the front face of the ferrule without being epoxied or otherwise affixed in the front bore segments. Then, when two connectors are brought together so that their front faces abut, the fibers in the connector extending beyond the front face of the other connector will contact the front endfaces of the corresponding fibers in the other connector and be pushed back into the connector with the curvature in the cavity adapting to take up any excess length of each individual fiber. When the two connectors are uncoupled, the natural resilience of the fibers will cause them to straighten out again as much as permitted by the arched surface. Thus, the inherent resilience of the fibers can be used to provide the forward spring bias that is often provided by other mechanisms in fiber-to-fiber connector designs.

While the invention has so far been described in connection with multi fiber connectors, it also can be applied to single fiber connectors, such as to provide forward spring bias for direct fiber-to-fiber couplings as just mentioned.

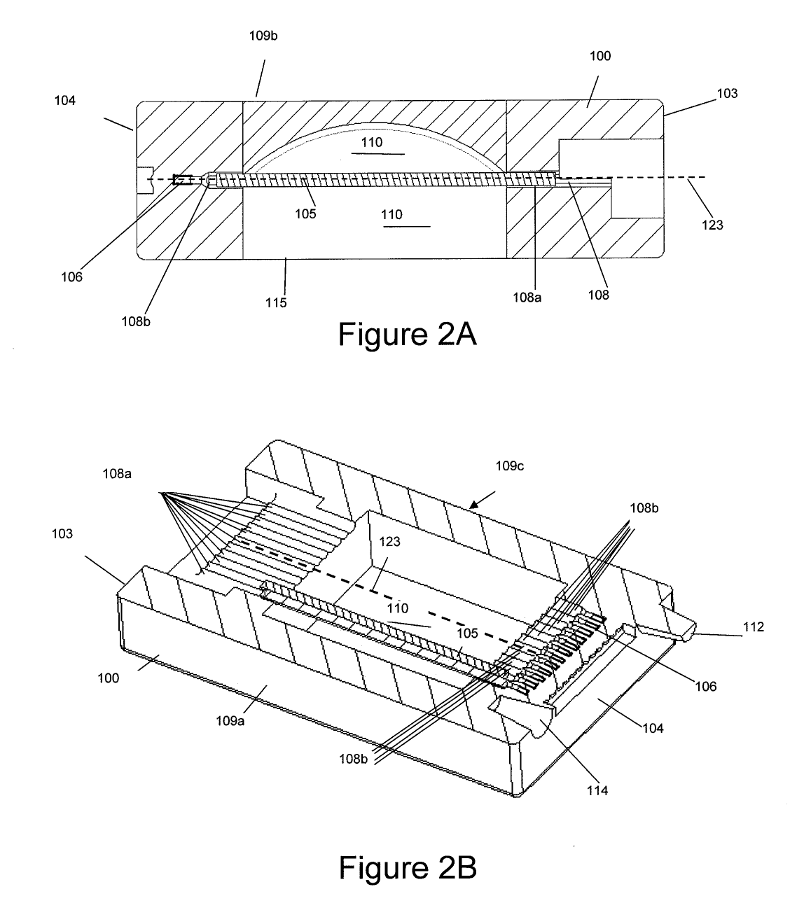

FIGS. 2A, 2B, 3, 4, and 5 illustrate stages of an assembly process in accordance with one embodiment. FIGS. 2A, 2B, 3, and 4 show only one of the fibers 105 (and, in fact, only the relevant segment of that fiber) in order to keep from making the Figures too busy and in order not to obfuscate the invention. However, it should be understood that typically there would actually be one fiber 105 per bore 108 and that the fibers would extend all the way out of the back 103 of the ferrule 100 as part of cable 102.

In a first stage, as illustrated in sectional views FIGS. 2A and 2B, fibers 105 are inserted into the ferrule 100 through the rear bore segments 108a, through the cavity 110 and most of the way into the front bore segments 108b. As previously noted, the fibers 105 should not yet be inserted far enough into the front bore segments 108b to cause the front end face of any of the fibers 105 to actually contact the front end of the bore as this may (1) cause them to bend in different directions and possibly interfere with each other and (2) damage the fibers because the fibers are relatively stiff and a stiff fiber with no bend previously introduced into it may require substantial longitudinal force against the lens before it starts to bend. On the other hand, the fibers 105 should be inserted far enough into the front bore segments 108b so that the front ends of the fibers will not be pulled out of the front bore segments 108b when the bends are induced.

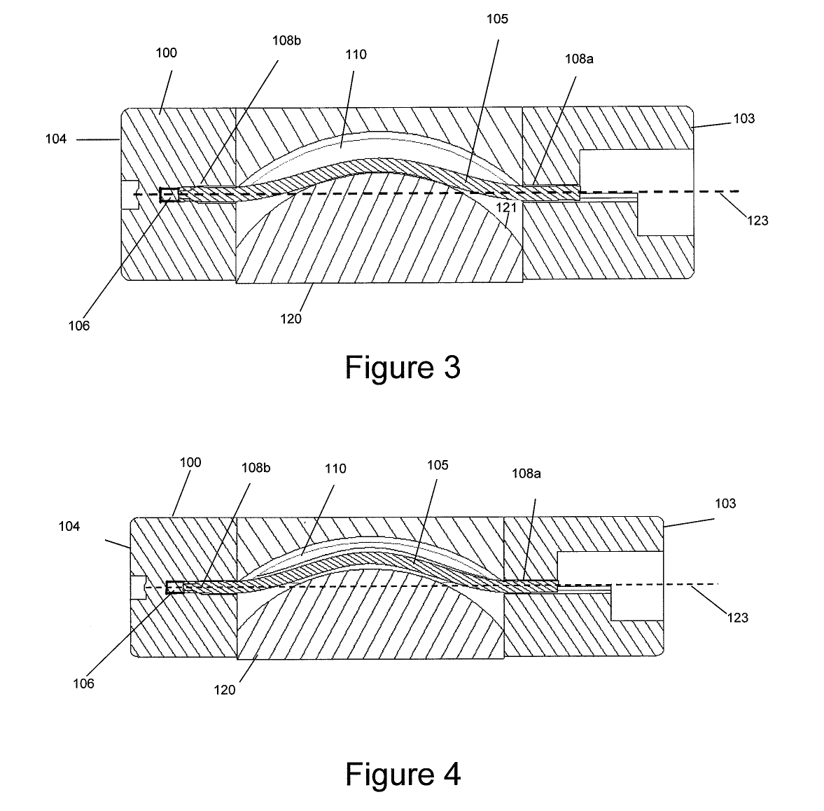

Referring next to FIG. 3, the plug 120 is inserted into the window, whereby the high portion of the convex surface 121 of the plug contacts the fibers 105 and causes them to bend.

Next, referring to FIG. 4, the fibers 105 are pushed farther forward into the ferrule 100 a sufficient distance to assure that even the shortest possible fiber will contact the rear face of its lens 106. The various fibers in the set of fibers will bend as much as individually needed to take up any excess length of the fibers.

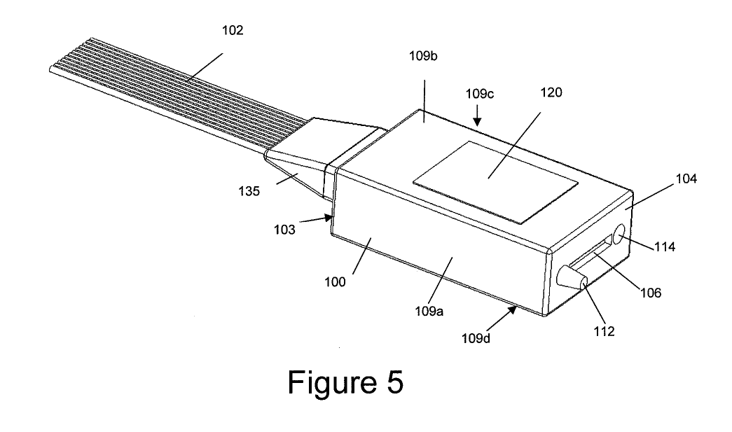

The process can be completed with any other steps necessary, such as injecting and/or curing any epoxy to affix the fibers in the bores, injecting and/or curing any epoxy around plug 120 to affix the plug 120 in window 115, affixing a strain relief boot 135 to the fibers at the rear of the ferrule, etc. The finished product is shown in FIG. 5.

The ferrule may be assembled within a suitable connector housing (not shown) to complete the connector.

While the invention has been described in connection with one particular style ferrule and a flat ribbon cable comprising one row of fibers, these features are exemplary and not limiting. The invention can be applied in many other applications, including applications in which the fibers are not arranged in a simple row. As an example, the invention can readily applied to connectors housing multiple rows of fibers stacked on top of each other. Inducing the bending in the first row would inherently induce similar bending in each overlying row of fibers.

Having thus described the few particular embodiments of the invention, various alterations, modifications, and improvements should be apparent to persons of skill in the related arts. Such alterations, modifications, and improvements as I made obvious by this disclosure are intended to be part of this description though not expressly stated herein, and are intended to be within the spirit and scope of the invention. Accordingly, the foregoing description is by way of example only, and not limited. The invention is limited only as defined in the following claims and equivalences thereto.

1. A ferrule comprising:
a ferrule body having a rear face and a front face and a side face extending there between;
at least one bore in the ferrule body for accepting an optical transport therein, the bore comprising a rear bore segment open to the rear face and a front bore segment; and
a cavity in the ferrule disposed between the rear bore segment and the front bore segment, the cavity providing sufficient space to allow the optical transport disposed in the bore and extending between the rear bore segment and the front bore segment to bend within a range of curvatures.

2. The ferrule of claim 1 further comprising an abutment surface in the bore against which the optical transport will abut.

3. The ferrule of claim 2 further comprising a lens disposed in the front bore segment between a front end of the bore and the front face wherein the abutment surface is a face of the lens.

4. The ferrule of claim 1 further comprising:
an arched surface in the cavity that interrupts the natural path of the optical transport between the rear bore segment and the front bore segment so that the optical transport must bend around the surface to extend between a rear bore segment and the corresponding front bore segment.

5. The ferrule of claim 4 wherein the arched surface is arched in a longitudinal direction of the optical transport.

6. The ferrule of claim 1 further comprising:
a window in the side face in communication with the cavity.

7. The ferrule of claim 6 further comprising:
a plug filling the window, the plug having an arched surface extending into the cavity that interrupts the natural path of the optical transport between the rear bore segment and the front bore segment so that the optical transport must bend around the arched surface to extend between a rear bore segment and the front bore segment.

8. An optical cable assembly comprising:
an optical cable having at least one optical transport;
a ferrule body having a rear face and a front face and a side face extending between the front face and the rear face;
at least one bore for accepting the at least one optical transport therein, the bore comprising a rear bore segment open to the rear face and oriented in a longitudinal direction toward the front face and a front bore segment, wherein the optical transport is disposed within the bore; and
a cavity disposed between the rear bore segment and the front bore segment, the cavity providing sufficient space to allow the optical transport to bend within a range of curvatures in the cavity;
wherein the optical transport is bent in the cavity.

9. The optical cable assembly of claim 8 further comprising a lens disposed in the front bore segment, and wherein the optical transport abuts the lens.

10. The optical cable assembly of claim 8 wherein the at least one optical transport comprises a plurality of optical transports and the at least one bore comprises a plurality of bores.

11. The optical cable assembly of claim 10 further comprising:
an arched surface in the cavity that interrupts the natural path of the optical transports between the rear bore segments and the corresponding front bore segments.

12. The optical cable assembly of claim 11 wherein the arched surface is arched in a longitudinal direction of the optical transports.

13. The optical cable assembly of claim 8 further comprising:
a window in the at least one side face in communication with the cavity.

14. The optical cable assembly of claim 13 further comprising:
a plug filling the window, the plug having an arched surface extending into the cavity that occupies space between each rear bore segment and the corresponding front bore segment so that an optical transport must bend around the surface to extend between a rear bore segment and the corresponding front bore segment.

15. A method of terminating an optical cable comprising a plurality of optical transports, the method comprising:
providing a ferrule having a rear face and a front face and a side face extending there between, a plurality of bores for accepting optical transports therein, each bore comprising a rear bore segment open to the rear face and oriented in a longitudinal direction toward the front face and a front bore segment collinear with the corresponding rear bore segment, the front bore segment having an end surface, and a cavity disposed between the rear bore segments and the front bore segments, the cavity providing sufficient space to allow optical transports extending between the rear bore segments and the front bore segments to bend within a range of curvatures within the cavity;
advancing a plurality of optical transports of a cable into the ferrule;
inducing a bend in each optical transport; and
subsequently advancing the cable farther into the ferrule sufficiently to cause each optical transport to abut the end face of the front bore segment that it is within.

16. The method of claim 15 wherein the advancing comprises advancing each optical transport into and through one of the rear bore segments, through the cavity, and into one of the front bore segments and not abutting the end surface of the front bore segment and wherein the inducing occurs subsequently to the first advancing.

17. The method of claim 15 wherein the inducing comprises inducing each optical transport to bend in the same direction.

18. The method of claim 15 wherein the inducing comprises applying a lateral force on portions of the optical transports within the cavity.

19. The method of claim 16 wherein the inducing comprises applying the lateral force with a tool.

20. The method of claim 16 wherein the ferrule further comprises a window in the side surface of the ferrule in communication with the cavity and wherein the inducing comprises inserting a plug in the window, the plug including an arched surface that intrudes into the cavity and contacts the optical transports to apply the lateral force.
